(19) United States
(12) Patent Application Publication
(10) Pub. No.: US 2025/0304072 A1
(43) Pub. Date: Oct. 2, 2025

(54) LANE CHANGE ASSISTANCE DEVICE

(71) Applicant: HONDA MOTOR CO., LTD., Tokyo (JP)

(72) Inventor: Tomotaka TERAMACHI, Tokyo (JP)

(73) Assignee: HONDA MOTOR CO., LTD., Tokyo (JP)

(21) Appl. No.: 19/034,607

(22) Filed: Jan. 23, 2025

(30) Foreign Application Priority Data
Mar. 27, 2024 (JP) 2024-051255

(51) Int. Cl. B60W 30/18

(52) U.S. Cl. CPC B60W 30/18163; B60W 2540/20; B60W 2552/10; B60W 2554/801

(57) ABSTRACT

A lane change assistance device, which is capable of assisting lane change of an own vehicle from an own lane in which the own vehicle travels to an adjacent lane adjacent to the own lane, includes: a recognition unit configured to recognize a surrounding situation of the own vehicle; and a lane change execution unit configured to perform the lane change based on the surrounding situation recognized by the recognition unit, and the lane change execution unit executes a first lane change control as defined herein in response to an operation on a predetermined operator provided in the own vehicle.

### CROSS-REFERENCE TO RELATED APPLICATION

This application is based on and claims priority under 35 USC 119 from Japanese Patent Application No. 2024-051255 filed on Mar. 27, 2024.

### TECHNICAL FIELD

The present invention relates to a lane change assistance device.

### BACKGROUND ART

In recent years, active efforts have been made to provide access to a sustainable transportation system in consideration of vulnerable traffic participants. As one of these efforts, research and development on driving assist techniques and automated driving techniques for vehicles such as automobiles have been made in order to further improve safety and convenience of traffic. As an example of the driving assist techniques, Patent Literature 1 discloses an assistance device (travel control device) that causes an own vehicle to execute a lane change from an own lane to an adjacent lane.

### PATENT LITERATURE

Patent Literature 1: JP6451854B

### SUMMARY OF INVENTION

However, in the conventional art, there is room for improvement in terms of reducing an effort required from an occupant of an own vehicle while increasing possibility of executing lane change intended by the occupant of the own vehicle.

The present invention provides a lane change assistance device that can reduce an effort required from an occupant of an own vehicle while increasing possibility of executing lane change intended by the occupant of the own vehicle.

An aspect of the present invention is a lane change assistance device capable of assisting lane change of an own vehicle from an own lane in which the own vehicle travels to an adjacent lane adjacent to the own lane, the lane change assistance device including:
a recognition unit configured to recognize a surrounding situation of the own vehicle; and
a lane change execution unit configured to perform the lane change based on the surrounding situation recognized by the recognition unit, in which
the lane change execution unit executes a first lane change control in response to an operation on a predetermined operator provided in the own vehicle, the first lane change control including
   performing a first determination to determine whether the lane change is possible based on the surrounding situation,
   if the lane change is determined to be impossible in the first determination, transitioning to a standby state in which execution of the lane change is on standby,
   after transitioning to the standby state, performing a second determination to determine whether the lane change is possible based on the surrounding situation, and
   if the lane change is determined to be possible in the second determination, performing the lane change.

According to the present invention, it is possible to reduce an effort required from an occupant of an own vehicle while increasing possibility of executing lane change intended by the occupant of the own vehicle. The term “own vehicle” used herein means merely a vehicle for which the lane change assistance device intends to assist lane change.

### BRIEF DESCRIPTION OF DRAWINGS

FIG. 1 is a block diagram showing an overall configuration of a vehicle system 1 on which a control device 100 according to the present embodiment is mounted;

FIG. 2 is a diagram showing an example of a steering wheel 82, a blinker lever 81, an operation switch SW1, and an approval selection switch SW2;

FIG. 3 is a diagram showing a specific example of an operation on the blinker lever 81;

FIG. 4 is a diagram showing an example of configurations of a first control unit 120 and a second control unit 160;

FIG. 5 is a diagram showing an example of a lane change operation of an own vehicle M by the control device 100;

FIG. 6 is a graph for illustrating an example of a threshold α and a threshold β according to an elapsed time (or a movement distance) in a standby state;

FIG. 7 is a graph for illustrating the other example of the threshold α and the threshold β according to the elapsed time (or the movement distance) in the standby state;

FIG. 8 is a flowchart showing an example of lane change assistance processing executed by the control device 100;

FIG. 9 is a flowchart showing an example of first lane change possibility determination processing executed by the control device 100;

FIG. 10 is a flowchart showing an example of first determination processing executed by the control device 100;

FIG. 11 is a flowchart showing an example of second determination processing executed by the control device 100;

FIG. 12 is a flowchart showing an example of second lane change possibility determination processing executed by the control device 100;

FIG. 13 is a flowchart showing the other example of the lane change assistance processing executed by the control device 100; and

FIG. 14 is a flowchart showing an example of third lane change possibility determination processing executed by the control device 100.

### DETAILED DESCRIPTION OF THE INVENTION

Hereinafter, an embodiment of a lane change assistance device according to the present invention will be described with reference to the drawings.

### Overall Configuration of Vehicle System 1

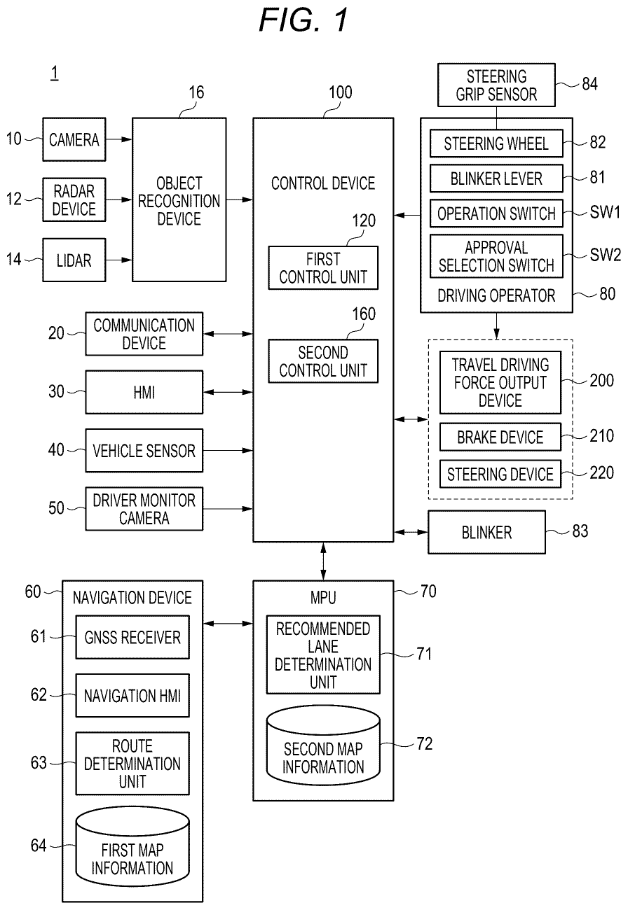

FIG. 1 is a block diagram showing an overall configuration of a vehicle system 1 on which a control device 100 as an embodiment of a lane change assistance device according to the present invention is mounted. A vehicle on which the vehicle system 1 is mounted (hereinafter, referred to as a “own vehicle M”) is, for example, a vehicle such as a two-wheeled vehicle, a three-wheeled vehicle, or a four-wheeled vehicle, and a driving force source thereof is an internal combustion engine such as a diesel engine or a gasoline engine, an electric motor, or a combination thereof. The electric motor operates using electric power generated by an electric generator connected to the internal combustion engine or electric power discharged from a secondary battery or a fuel cell.

In the own vehicle M, automated driving and driving assistance in which a driving operation is autonomously controlled to cause the own vehicle M to travel are possible. The automated driving defined here refers to that all driving operations such as recognizing or monitoring a travel environment and a surrounding situation, as well as starting, accelerating and decelerating, steering, and stopping are performed by a system of the vehicle. The driving assistance here refers to that the system of the vehicle performs a part of driving operations such as starting, accelerating and decelerating, steering, and stopping. Especially, in the embodiment described below, an example will be described in which lane change assistance is executed during lane change from an own lane as a lane in which the own vehicle M travels to an adjacent lane adjacent to the own lane. It should be noted that, as is well-known in the conventional art, there is a plurality of levels of driving control in the automated driving and driving assistance, and the levels may be defined, for example, as levels 0 to 5 established by the Society of Automotive Engineers (SAE) of the United States. Regarding the levels of the driving control, the larger the level number, the lighter an operational burden on a driver (in other words, the larger the level number, the higher a degree of automation). It should be noted that specific contents of levels 0 to 5 are well-known, and thus descriptions thereof are omitted here.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a driver monitor camera 50, a navigation device 60, a map positioning unit (MPU) 70, a driving operator 80, a blinker 83, the control device 100, a travel driving force output device 200, a brake device 210, and a steering device 220. These devices and equipment are connected to each other via, for example, a multiplex communication line such as a controller area network (CAN) communication line, a serial communication line, or a wireless communication network.

The camera 10 is, for example, a digital camera using a solid-state imaging device such as a charge coupled device (CCD) or a complementary metal oxide semiconductor (CMOS). The camera 10 is attached to any portion of the own vehicle M on which the vehicle system 1 is mounted.

The radar device 12 emits radio waves such as millimeter waves to surroundings of the own vehicle M, and detects radio waves (reflected waves) reflected by an object to detect at least a position (distance and orientation) of the object. The radar device 12 is attached to any portion of the own vehicle M.

The LIDAR 14 emits light (or an electromagnetic wave having a wavelength close to that of light) to the surroundings of the own vehicle M and measures scattered light. The LIDAR 14 detects a distance to a target based on a time elapsed from light emission to light reception. The emitted light is, for example, pulsed laser light. The LIDAR 14 is attached to any portion of the own vehicle M.

The object recognition device 16 executes sensor fusion processing on some or all of detection results of the camera 10, the radar device 12, and the LIDAR 14 to recognize a position, a type, a speed, and the like of an object. The object recognition device 16 outputs a recognition result to the control device 100. The object recognition device 16 may output the detection results of the camera 10, the radar device 12, and the LIDAR 14 to the control device 100 as they are.

The communication device 20 uses, for example, a cellular network, a Wi-Fi (registered trademark) network, Bluetooth (registered trademark), or dedicated short range communication (DSRC) to communicate with other vehicles present in the surroundings of the own vehicle M or communicate with various server devices via a radio base station.

The HMI 30 presents various information to an occupant of the own vehicle M and receives an input operation performed by the occupant. The HMI 30 includes various display devices, a speaker, a buzzer, a touch panel, a switch, a key, and the like.

The vehicle sensor 40 includes a vehicle speed sensor that detects a travel speed (so-called “vehicle speed”; hereinafter also simply referred to as a “speed”) of the own vehicle M, an acceleration sensor that detects an acceleration, a yaw rate sensor that detects an angular speed around a vertical axis, an azimuth sensor that detects an orientation of the own vehicle M, and the like.

The driver monitor camera 50 is, for example, a digital camera using a solid-state imaging device such as a CCD or a CMOS. The driver monitor camera 50 is attached to any portion of the own vehicle M in a position and an orientation in which a head of the occupant seated in a driver's seat of the own vehicle M can be imaged from a front side (that is, in an orientation in which a face can be imaged).

The navigation device 60 includes, for example, a global navigation satellite system (GNSS) receiver 61, a navigation HMI 62, and a route determination unit 63.

The navigation device 60 stores first map information 64 in a storage device such as a hard disk drive (HDD) or a flash memory.

The GNSS receiver 61 specifies a position of the own vehicle M based on a signal received from a GNSS satellite. The position of the own vehicle M may be specified or complemented by an inertial navigation system (INS) using an output of the vehicle sensor 40.

The navigation HMI 62 includes a display device, a speaker, a touch panel, a key, and the like. The navigation HMI 62 may be partially or entirely shared with the HMI 30 described above.

For example, with reference to the first map information 64, the route determination unit 63 determines a route (hereinafter, also referred to as an “on-map route”) from the position of the own vehicle M specified by the GNSS receiver 61 (or an input any position) to a destination input by the occupant using the navigation HMI 62. The first map information 64 is, for example, information in which a road shape is expressed by a link indicating a road and nodes connected by the link. The first map information 64 may include a curvature of a road, point of interest (POI) information, and the like. The on-map route is output to the MPU 70.

The navigation device 60 may perform route guidance using the navigation HMI 62 based on the on-map route. The navigation device 60 may transmit a current position and the destination to a navigation server via the communication device 20 and acquire a route equivalent to the on-map route from the navigation server.

The MPU 70 includes, for example, a recommended lane determination unit 71, and stores second map information 72 in a storage device such as an HDD or a flash memory. The recommended lane determination unit 71 divides the on-map route provided by the navigation device 60 into a plurality of blocks (for example, divides the on-map route by 100 [m] in a vehicle traveling direction), and determines a recommended lane for each block with reference to the second map information 72. For example, the recommended lane determination unit 71 determines which lane from the left the vehicle is to travel in. When a branch point is present in the on-map route, the recommended lane determination unit 71 determines a recommended lane such that the own vehicle M may travel along a reasonable route for advancing to a branch destination.

The second map information 72 is map information with higher accuracy than the first map information 64. The second map information 72 includes, for example, information on a center of a lane or information on a boundary of the lane. The second map information 72 may include road information, traffic regulation information, address information, facility information, telephone number information, and the like. The second map information 72 may be updated, as required, by the communication device 20 communicating with another device.

The driving operator 80 includes, for example, a blinker lever 81, a steering wheel 82, an accelerator pedal, a brake pedal, a shift lever, and other operators. Other operators include, for example, an operation switch SW1 for making a lane change request (hereinafter also referred to as an “operation switch SW1”), and an approval selection switch SW2 which is operated when the occupant of the own vehicle M agrees to a lane change suggestion from the control device 100 (hereinafter also referred to as an “approval selection switch SW2”). A sensor (not shown) that detects an operation amount or presence or absence of an operation is attached to these driving operators 80, and a detection result thereof is output to some or all of the control device 100, the travel driving force output device 200, the brake device 210, and the steering device 220.

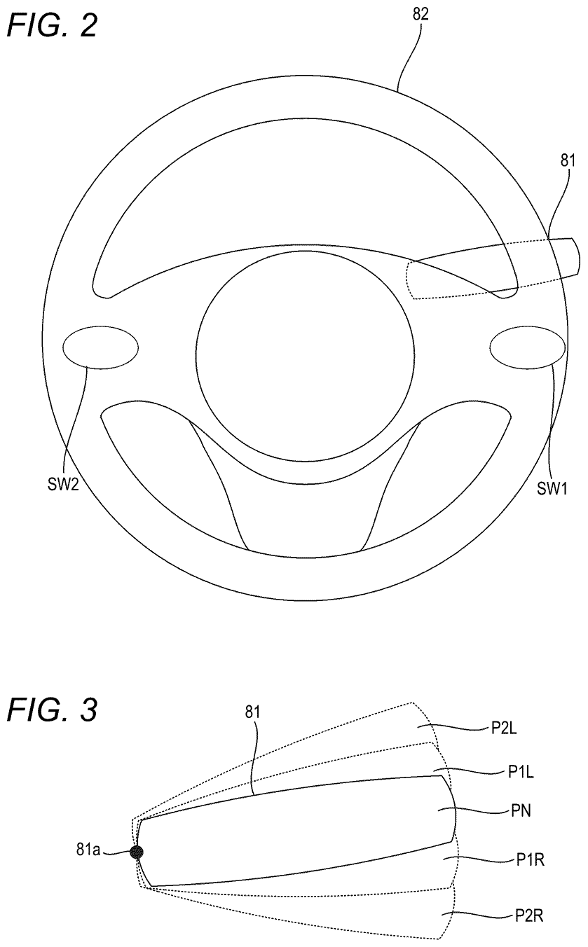

FIG. 2 is a diagram showing an example of the steering wheel 82, the blinker lever 81, the operation switch SW1, and the approval selection switch SW2. The steering wheel 82 is an operator for receiving a steering operation. The steering wheel 82 is not necessarily in an annular shape as shown in FIG. 2, and may be in a form of deformed steering, joy stick, a button, or the like. A steering grip sensor 84 is attached to the steering wheel 82 (as shown in FIG. 1). The steering grip sensor 84 is implemented by a static capacitance sensor or the like, and outputs, to the control device 100, a signal capable of detecting whether the driver is gripping the steering wheel 82.

The blinker lever 81 is an operator for turning on or off the blinker 83, and also functions as an operator for receiving an operation as a lane change request. As shown in FIG. 2, the blinker lever 81 is, for example, in a shape that allows the driver to perform a blind operation with one hand for gripping (for example, one finger of a right hand) while the driver grips the steering wheel 82, and is disposed at a position that allows such an operation. The control device 100 described later detects the lane change request from the driver based on a predetermined operation on the blinker lever 81 performed by the driver.

The operation switch SW1 is an operator for receiving a lane change request different from the blinker lever 81, and is provided at a predetermined position on the steering wheel 82, for example. The occupant operates this operation switch SW1 to make a lane change request to the control device 100. It should be noted that the operation switch SW1 is an example of the “operator different from a blinker lever” in the present disclosure. The operation switch SW1 may be a switch type, or may be, for example, a tilt mechanism that can be switched left and right, or may be shared with other switches, buttons, or the like.

The approval selection switch SW2 is an operator to be operated when the occupant of the own vehicle M agrees to a lane change suggestion from the control device 100, and is provided at a predetermined position on the steering wheel 82, for example. For example, when the occupant agrees to a lane change suggestion from the control device 100, an operation on the approval selection switch SW2 is an example of an operation to indicate the agreement. It should be noted that the approval selection switch SW2 may be a switch type or a button type, or may be shared with other switches, buttons, or the like.

The blinker 83 is a turn signal provided on each of a left side (for example, left front and left rear) and a right side (for example, right front and right rear) of the own vehicle M and at a position visible from the outside of the own vehicle M. The control device 100 turns on (including flickering) or off the blinker 83 in response to an operation on a predetermined operator such as the blinker lever 81, the operation switch SW1, and the approval selection switch SW2.

Here, an operation on the blinker lever 81 will be described. FIG. 3 is a diagram showing a specific example of an operation on the blinker lever 81. As shown in FIG. 3, the blinker lever 81 is pivotable around a support shaft 81a. A neutral position PN, shallow push positions PIL and PIR, and deep push positions P2L and P2R are positions at which the blinker lever 81 can be displaced by pivoting.

The neutral position PN is a position where the blinker lever 81 is not operated, and when the blinker lever 81 is in the neutral position PN, the blinker 83 is turned off.

The shallow push position PIL is a half-way position pivoted counterclockwise by a predetermined amount from the neutral position PN. The deep push position P2L is an end position pivoted further counterclockwise by a predetermined amount from the shallow push position PIL. The shallow push position PIR is a half-way position pivoted clockwise by a predetermined amount from the neutral position PN. The deep push position P2R is an end position pivoted further clockwise by a predetermined amount from the shallow push position PIR.

When the blinker lever 81 is pushed to the shallow push position PIL or PIR by the driver, a click feeling is given to the driver, and when an operation force to the blinker lever 81 is released from this state, the blinker lever 81 is mechanically returned to the neutral position PN by a return mechanism (not shown) such as a spring. When the blinker lever 81 is pushed to the deep push position P2L or P2R by the driver, the blinker lever 81 is held at the deep push position P2L or P2R by a mechanical lock mechanism (not shown) even when an operation force is released.

The blinker lever 81 is provided with a switch (not shown). The control device 100 may determine whether the blinker lever 81 is at the neutral position PN, the shallow push position PIL or PIR, or the deep push position P2L or P2R based on a detection result by the switch.

In a state where the blinker lever 81 is held at the deep push position P2L or P2R, when the steering wheel 82 is reversely rotated and the blinker lever 81 is returned to the neutral position, or when the driver returns the blinker lever 81 in a neutral position direction, the lock by the lock mechanism is released and the blinker lever 81 is returned to the neutral position PN. That is, when the blinker lever 81 is operated to the deep push position P2L or P2R, the blinker lever 81 operates in the same manner as a blinker flickering device generally implemented in the conventional art.

Hereinafter, an operation of maintaining the blinker lever 81 at the shallow push position PIL or the shallow push position PIR is referred to as a “half-lock operation”. The half-lock operation is an example of the “predetermined operation” in the present disclosure. For example, the control device 100 determines that there is a lane change request when the half-lock operation of the blinker lever 81 continues for a predetermined time or more. Here, the predetermined time is a time necessary for confirming an intention of the driver to execute the lane change, and is, for example, 1.0 [sec].

The control device 100 is a computer that integrally controls the entire own vehicle M, and includes, for example, a first control unit 120 and a second control unit 160. Each of the first control unit 120 and the second control unit 160 is implemented by, for example, a hardware processor such as a central processing unit (CPU) executing a program (software). Some or all of these constituent elements may be implemented by hardware (including circuitry) such as a large scale integration (LSI), an application specific integrated circuit (ASIC), a field-programmable gate array (FPGA), and a graphics processing unit (GPU), or may be implemented by cooperation of software and hardware. The program may be stored in advance in a storage device such as an HDD or a flash memory of the control device 100.

### Configurations of First Control Unit 120 and Second Control Unit 160

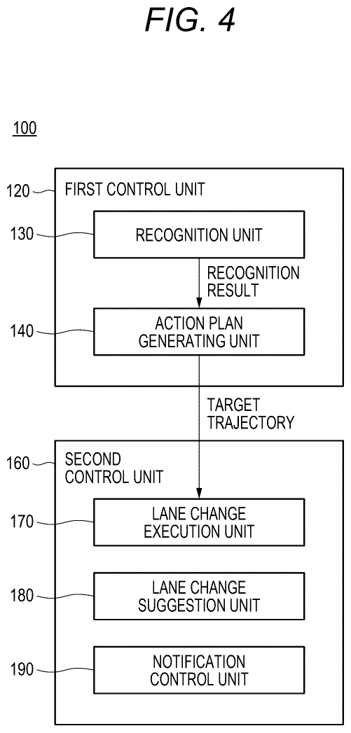

FIG. 4 is a diagram showing an example of configurations of the first control unit 120 and the second control unit 160. The first control unit 120 includes, for example, a recognition unit 130 and an action plan generating unit 140. The first control unit 120 and the second control unit 160 execute lane change assistance processing, which is an example of a program stored in a storage medium, for performing lane change of the own vehicle M to the adjacent lane. When the program is executed, the first control unit 120 functions as the recognition unit 130 and the action plan generating unit 140. The second control unit 160 also functions as a lane change execution unit 170, a lane change suggestion unit 180, and a notification control unit 190, which will be described later.

The first control unit 120 implements, for example, a function based on artificial intelligence (AI) and a function based on a model given in advance in parallel. For example, a function of “recognizing a crossing point” may be implemented by performing recognition of a crossing point by deep learning or the like and recognition based on a condition given in advance (signal enabling pattern matching, road marking, or the like) in parallel and performing comprehensive evaluation by scoring the both recognition. Accordingly, reliability of automated driving is ensured.

The recognition unit 130 recognizes a surrounding situation of the own vehicle M based on information input from the camera 10, the radar device 12, and the LIDAR 14 via the object recognition device 16. Specifically, the recognition unit 130 recognizes a position of an object in the surroundings of the own vehicle M, and a traveling state including a speed, an acceleration, and the like of the object. For example, the position of the object is recognized as a position on absolute coordinates with a representative point (center of gravity, drive shaft center, or the like) of the own vehicle M as an origin, and is used for control. The position of the object may be represented by a representative point such as a center of gravity or a corner of the object, or may be represented by a region. The “state” of the object may include an acceleration or jerk of the object, or an “action state” (for example, whether the lane change is in progress, or whether the lane change is to be performed). The object recognized by the recognition unit 130 includes the other vehicle (hereinafter, also referred to as a “front vehicle”) M1 traveling in front of the own vehicle M and the other vehicle (hereinafter, also referred to as a “rear vehicle”) M2 traveling behind the own vehicle M.

For example, the recognition unit 130 recognizes a travel environment in which the own vehicle M travels. For example, the recognition unit 130 recognizes a travel lane of the own vehicle M by comparing a pattern of road division lines (for example, an array of solid lines and broken lines) obtained from the second map information 72 with a pattern of road division lines in the surroundings of the own vehicle M recognized from an image captured by the camera 10. It should be noted that the recognition unit 130 may recognize the travel lane by recognizing not only the road division lines but also a course boundary (road boundary) including a road division line, a road shoulder, a curbstone, a median strip, a guard rail, and the like. In the recognition, the position of the own vehicle M acquired from the navigation device 60 or a processing result of the INS may be taken into consideration. The recognition unit 130 may recognize a temporary stop line, an obstacle, a red signal, a tollgate, and other road events.

When recognizing the travel lane, the recognition unit 130 recognizes a position and a posture of the own vehicle M with respect to the travel lane. For example, the recognition unit 130 may recognize a deviation of a reference point of the own vehicle M from a lane center and an angle between a traveling direction of the own vehicle M and a lane center line, as a relative position and a posture of the own vehicle M with respect to the travel lane. Alternatively, the recognition unit 130 may recognize a position of the reference point of the own vehicle M with respect to any side end portion (road division line or road boundary) of the travel lane as the relative position of the own vehicle M with respect to the travel lane.

For example, the action plan generating unit 140 generates a target trajectory in which the own vehicle M travels in a recommended lane determined by the recommended lane determination unit 71, and further automatically travels in the future (without any operation by the driver) so as to correspond to the surrounding situation of the own vehicle M. The generated target trajectory is stored in a storage medium (not shown), and the control device 100 controls the travel driving force output device 200 (shown in FIG. 1) and the brake device 210 (shown in FIG. 1), which will be described later, by referring to the target trajectory stored in the storage medium.

The target trajectory includes, for example, a speed element. For example, the target trajectory is represented by arranging points (trajectory points) to be reached by the own vehicle M in order. The trajectory point is a point to be reached by the own vehicle M for each predetermined travel distance (for example, about several meters) in a road distance, and separately, a target speed and a target acceleration for each predetermined sampling time (for example, about a few fractions of a second) are generated as a part of the target trajectory. The trajectory point may be a position to be reached by the own vehicle M at a sampling time point within each predetermined sampling time. In this case, information on the target speed and the target acceleration is expressed by an interval of the trajectory points.

It should be noted that the action plan generating unit 140 may set an event of automated driving when generating the target trajectory. The event of the automated driving includes a constant speed traveling event, a low speed following traveling event, a lane change event, a branching event, a merging event, a take over event, and the like. As an example, the action plan generating unit 140 may set a lane change event in response to a lane change request from the driver. When these events are set, the action plan generating unit 140 generates a target trajectory according to the set events.

The second control unit 160 controls the own vehicle M to pass through, at a scheduled time point, the target trajectory generated by the action plan generating unit 140. As described above, the second control unit 160 includes the lane change execution unit 170, the lane change suggestion unit 180, and the notification control unit 190.

The lane change execution unit 170 performs lane change based on the surrounding situation recognized by the recognition unit 130. Specifically, when other vehicles traveling in an adjacent lane adjacent to the travel lane of the own vehicle M (hereinafter referred to as the “adjacent lane”) are detected, the lane change execution unit 170 determines whether the lane change is possible based on a vehicle-to-vehicle distance L between the front vehicle M1 traveling in front of the own vehicle M and the rear vehicle M2 traveling behind the own vehicle M in the adjacent lane. Then, when a positive determination is made in the determination as to whether the lane change is possible (that is, when the lane change is determined to be possible), the lane change execution unit 170 executes the lane change. It should be noted that, when other vehicles traveling in the adjacent lane are detected, whether the lane change is possible may be determined based on a relative speed between the own vehicle M and the other vehicle (the front vehicle M1, the rear vehicle M2), or a vehicle-to-vehicle distance between the own vehicle M and the other vehicle (the front vehicle M1, the rear vehicle M2), in addition to the vehicle-to-vehicle distance L between the front vehicle M1 traveling in front of the own vehicle M and the rear vehicle M2 traveling behind the own vehicle M. In the present embodiment, an example will be described in which whether the lane change is possible is determined based on the vehicle-to-vehicle distance L between the front vehicle M1 and the rear vehicle M2.

The lane change execution unit 170 selects a program for the lane change assistance processing to be executed depending on whether the lane change by the occupant of the own vehicle M is triggered by a half-lock operation on the blinker lever 81 or an operation on the operation switch SW1. For example, when the lane change by the occupant is triggered by an operation on the operation switch SW1, a first lane change control is executed as a program for the lane change assistance processing. For example, when the lane change by the occupant is triggered by a half-lock operation on the blinker lever 81, a second lane change control is executed as a program for the lane change assistance processing. Furthermore, the lane change execution unit 170 may execute a third lane change control as a program for the lane change assistance processing when the lane change suggestion unit 180 described below makes a suggestion on the lane change to the occupant and the occupant performs an operation to agree to the suggestion. Specific contents of the various lane change assistance processing performed by the control device 100 through the functions of the lane change execution unit 170 will be described later, and therefore will not be described here.

It should be noted that the action plan generating unit 140 sets a lane change event or generates a target trajectory according to the lane change event based on that the lane change execution unit 170 determines that the lane change is possible. The lane change execution unit 170 controls the travel driving force output device 200 (see FIG. 1) or the brake device 210 (see FIG. 1) based on the speed element accompanying the target trajectory. The lane change execution unit 170 controls the steering device 220 and the blinker 83 (see FIG. 1) according to a degree of curvature of the target trajectory stored in the storage medium. These kinds of processing is implemented by, for example, a combination of feedforward control and feedback control.

The lane change suggestion unit 180 makes a suggestion on the lane change to the occupant of the own vehicle M. Specifically, the lane change suggestion unit 180 makes a suggestion on the lane change to the occupant of the own vehicle M based on the surrounding situation recognized by the recognition unit 130, the target trajectory generated by the action plan generating unit 140 (or the target trajectory stored in the storage medium by the action plan generating unit 140), or the like. As an example, the lane change suggestion unit 180 may make a suggestion on the lane change to the occupant of the own vehicle M when there is a front vehicle M1 in front of the own vehicle M and traveling at a slower speed than the own vehicle M in the own lane. As another example, the lane change suggestion unit 180 may make a suggestion on the lane change to the occupant of the own vehicle M when the own vehicle M is traveling in a lane other than the recommended lane determined by the recommended lane determination unit 71, that is, when the own lane is other than the recommended lane.

Then, if the occupant of the own vehicle M agrees to the suggestion on the lane change made by the lane change suggestion unit 180 by operating the approval selection switch SW2 or the like, the lane change is executed by the lane change execution unit 170. In this case, the program for the lane change to be executed is the third lane change control as described above. Specific contents of the lane change by this third lane change control will be described later, and therefore will not be described here. It should be noted that the lane change based on the lane change suggestion unit 180 is not triggered by the half-lock operation on the blinker lever 81 or the operation of the operation switch SW1 described above, but the operation on the approval selection switch SW2 (that is, agreement) by the occupant in response to the suggestion on the lane change.

The notification control unit 190 controls the HMI 30, the navigation HMI 62, and the like, to notify the occupant of the own vehicle M (for example, the driver) of various information. For example, when the control device 100 suspends the lane change, the notification control unit 190 performs the notification by causing the HMI 30, the navigation HMI 62, or the like to display a message indicating that the lane change is suspended (a message such as “lane change suspended”). For example, when the control device 100 makes the lane change be on standby, the notification control unit 190 performs the notification by causing the HMI 30, the navigation HMI 62, or the like to display a message indicating that the lane change is on standby (a message such as “lane change on standby”). For example, when the control device 100 completes the lane change, the notification control unit 190 performs the notification by causing the HMI 30, the navigation HMI 62, or the like to display a message indicating that the lane change is completed (a message such as “lane change completed”). For example, when the control device 100 uses the function of the lane change suggestion unit 180 to make a suggestion on the lane change to the occupant, the notification control unit 190 performs the notification by causing the HMI 30, the navigation HMI 62, or the like to display a message indicating that a suggestion on lane change is made (a message such as “Do you want to change lanes”).

With reference to FIG. 1 again, the travel driving force output device 200 outputs, to driving wheels, a travel driving force (torque) for driving the vehicle to travel. The travel driving force output device 200 includes, for example, a combination of an internal combustion engine, an electric motor, a transmission, and the like, and an electronic control unit (ECU) configured to control the above configurations (all not shown). The ECU controls each device according to information received from the second control unit 160 or information received from the driving operator 80.

The brake device 210 includes, for example, a brake caliper, a cylinder that transmits a hydraulic pressure to the brake caliper, an electric motor that generates the hydraulic pressure in the cylinder, and a brake ECU (all not shown). The brake ECU controls the electric motor according to the information received from the second control unit 160 or the information received from the driving operator 80, and outputs a braking torque to each wheel according to a braking operation.

The steering device 220 includes, for example, a steering ECU and an electric motor (both not shown). The electric motor changes an orientation of a steered wheel, for example, by applying a force to a rack-and-pinion mechanism. The steering ECU drives the electric motor according to the information received from the second control unit 160 or the information received from the driving operator 80 to change the orientation of the steered wheel.

### Lane Change Assistance Processing

Next, an example of the lane change assistance processing for executing the lane change of the own vehicle M will be specifically described. As described above, when a lane change request is made and the lane change execution unit 170 determines, using the function thereof, that the lane change is possible, the control device 100 executes the lane change of the own vehicle M. The lane change request is triggered by the occupant performing a half-lock operation on the blinker lever 81 or an operation on the operation switch SW1. In recent years, there are techniques available for lane change assistance through automated driving and driving assistance in response to such a lane change request, but there is room for improvement in terms of reducing an effort required from the occupant of the own vehicle M while increasing the possibility of executing the lane change intended by the occupant. Therefore, in the present embodiment, the control device 100 executes the following processing to increase the possibility of executing the lane change according to the intention of the occupant. Specifically, when the lane change request is triggered by the operation switch SW1, the control device 100 executes the first lane change control, and when the lane change request is triggered by a half-lock operation on the blinker lever 81, the control device 100 executes the second lane change control.

### Lane Change Operation

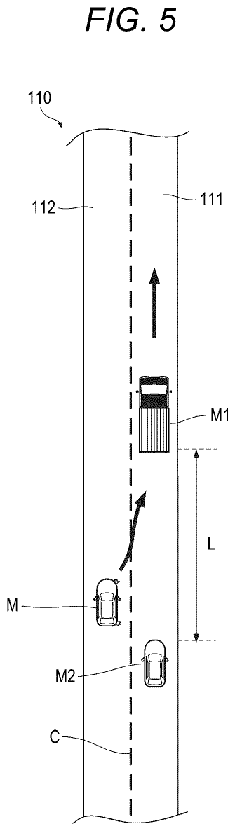

Here, an example of the lane change operation in the present embodiment will be described. FIG. 5 is a diagram showing an example of the lane change operation on the own vehicle M by the control device 100. A road (for example, a highway) 110 shown in FIG. 5 includes a right lane 111 and a left lane 112 with a traveling direction as a direction from a lower side to an upper side in FIG. 5. A division line C as a road division line is provided at a boundary between the right lane 111 and the left lane 112.

In the example shown in FIG. 5, the own vehicle M is traveling in the left lane 112 of the road 110. That is, in the example shown in FIG. 5, the left lane 112 corresponds to the own lane of the own vehicle M, and the right lane 111 corresponds to the adjacent lane for the own vehicle M. In the right lane 111, there are a front vehicle M1 in front of the own vehicle M and a rear vehicle M2 behind the own vehicle M. The vehicle-to-vehicle distance L between the front vehicle M1 and the rear vehicle M2 is a relatively short vehicle-to-vehicle distance when viewed from a relative position with respect to the own vehicle M.

In the state of the example shown in FIG. 5, it is assumed that the own vehicle Mis caused to perform lane change from the left lane 112 to the right lane 111, triggered by an operation on the operation switch SW1. The first lane change control and the second lane change control during lane change of the own vehicle M from the above state will be described below.

### First Lane Change Control

In the first lane change control, the control device 100 recognizes (or acquires) the surrounding situation of the own vehicle M in response to an operation on the operation switch SW1 through the function of the recognition unit 130. That is, the recognition unit 130 recognizes the surrounding situation of the own vehicle (for example, a traveling state of other vehicles) based on information input from the camera 10, the radar device 12, the LIDAR 14, and the like via the object recognition device 16, and based on the second map information 72. The other vehicles referred to here are, for example, the front vehicle M1 and the rear vehicle M2 traveling in the adjacent lane. The recognition unit 130 then acquires the vehicle-to-vehicle distance L between the front vehicle M1 and the rear vehicle M2 from the traveling states such as positions, speeds, and accelerations of the other vehicles. The recognition unit 130 may also acquire relative speeds between the own vehicle M and other vehicles and relative distances between the own vehicle M and other vehicles.

Next, the control device 100 performs a first determination, using the function of the lane change execution unit 170, to determine whether the lane change is possible. Here, the first determination is, for example, a determination as to whether a condition related to a relative distance between the own vehicle M and the other vehicle (front vehicle M1, rear vehicle M2) traveling in the adjacent lane is satisfied. As one example, predetermined thresholds are set for each of the vehicle-to-vehicle distance L between the front vehicle M1 and the rear vehicle M2 acquired by the above-mentioned recognition unit 130, the relative speed between the own vehicle M and the other vehicle, and the relative distance between the own vehicle M and the other vehicle, and if a value of each parameter is equal to or greater than the threshold, a positive determination is made in the first determination. It should be noted that at least one parameter may be used as the parameter indicating the condition related to the relative distance. In the following description, the vehicle-to-vehicle distance L between the front vehicle M1 and the rear vehicle M2 is representatively used as the parameter.

For example, when the own vehicle M performs lane change to a space between the front vehicle M1 and the rear vehicle M2, the threshold for the vehicle-to-vehicle distance L between the front vehicle M1 and the rear vehicle M2 is set to a length that enables the lane change while ensuring safety, and is a value that is at least greater than an overall length of the own vehicle M. The threshold may be determined, for example, according to a target speed of the own vehicle, and the higher the target speed, the higher the threshold. In addition, the value determined according to the target speed may be multiplied by a predetermined safety factor (for example, a value greater than “1”).

When it is determined that the vehicle-to-vehicle distance L between the front vehicle M1 and the rear vehicle M2 is less than a threshold α by the function of the lane change execution unit 170, the control device 100 determines that the lane change is impossible in the first determination, and transitions to a standby state in which the execution of the lane change of the own vehicle M is on standby. For example, when executing the lane change of the own vehicle M from the state shown in FIG. 5, as described above, since the vehicle-to-vehicle distance L between the front vehicle M1 and the rear vehicle M2 is relatively short, it is difficult to perform the lane change quickly (for example, 3.0 [sec] to 10.0 [sec]) after the operation switch SW1 is operated. In such a case, the control device 100 transitions to the standby state in which the lane change of the own vehicle M is temporarily on standby, and after transitioning to the standby state, performs a second determination to determine whether the lane change is possible.

Here, “transitions to the standby state . . . , and after transitioning to the standby state, . . . determine whether the lane change is possible” means that in a case of normal control, it is assumed that if the lane change is determined to be impossible, the lane change is suspended. However, in the present embodiment, even when the lane change is determined to be impossible in the first determination, the lane change is not immediately suspended, and the control device 100 maintains the traveling in the current travel lane while being on standby for a predetermined time, and determines whether the lane change is possible during this standby state. Then, during the standby state for the predetermined time, if the lane change is determined to be possible in the second determination, the control device 100 executes the lane change. That is, if the lane change is determined to be possible in the second determination, the standby state is released and the lane change is executed.

It should be noted that the standby time in the standby state is fluid since if the lane change is determined to be possible in the second determination during the standby state, the lane change will be executed. On the other hand, if the standby time is too long, the occupant may feel discomfort, and therefore, a maximum value of the standby time may be set to 1.0 [min], for example. It should be noted that the maximum value of the standby time (corresponding to a predetermined time described below) may be freely set in advance by a manufacturer of the own vehicle M or the like. That is, in the present embodiment, the second determination is executed repeatedly at a predetermined period (maximum 1.0 [sec]) in the standby state, and if the lane change is determined to be possible during this state, the lane change will be executed.

The second determination may be a determination having the same gist as the first determination described above. That is, the control device 100 determines whether the vehicle-to-vehicle distance L between the front vehicle M1 and the rear vehicle M2 is equal to or greater than a threshold (for example, a threshold β). Here, it is preferable that the threshold β is greater than the threshold α. Since the second determination is a determination as to whether the lane change is possible after transitioning to the standby state, it can be assumed that the occupant will be less vigilant about the surrounding situation than in the first determination, which is executed immediately after the operation switch SW1 is operated. In other words, since it can be assumed that the first determination is executed immediately after the occupant monitoring the surrounding situation, the monitoring of the surrounding situation in the first determination can be said to be a judgment based on the occupant and the function of the recognition unit 130. In contrast, since the second determination is executed after transitioning to the standby state, it can be assumed that the occupant is less vigilant about the surrounding situation than in the first determination. In other words, it can be said that there is an increased reliance on the function of the recognition unit 130 to monitor the surrounding situation. In consideration of such circumstances, in the present embodiment, the threshold β in the second determination is set to a value greater than the threshold α in the first determination. It should be noted that the above-mentioned condition related to the relative distance corresponds to the “first condition and second condition” in the present disclosure. Since the first condition and the second condition are determined by the above-mentioned thresholds, the second condition used in the second determination is stricter than the first condition used in the first determination. That is, in the present embodiment, the threshold β is a larger value than the threshold α, and thus is a condition stricter in the vehicle-to-vehicle distance L.

The threshold β in the second determination (that is, β in the second condition) is set to gradually increase according to an elapsed time or a movement distance. As described above, the second determination processing is repeatedly executed at a predetermined period in the standby state of the lane change of the own vehicle M. It is assumed that the occupant will become less vigilant about the surrounding situation due to the standby state. In other words, it can be said that the occupant will become less vigilant as the time in the standby state increases. In other words, the shorter the standby time, the more vigilant the occupant is about the surrounding situation, and if the lane change is executed while the occupant is highly vigilant about the surrounding situation, the lane change can be performed at a timing close to that intended by the occupant. Therefore, it is preferable to set the threshold β according to the elapsed time based on the standby state. Since the elapsed time can be converted into the movement distance, the determination may be made based on the movement distance instead of the elapsed time.

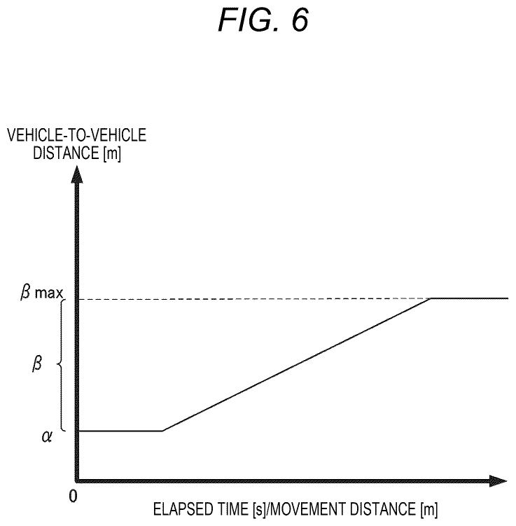

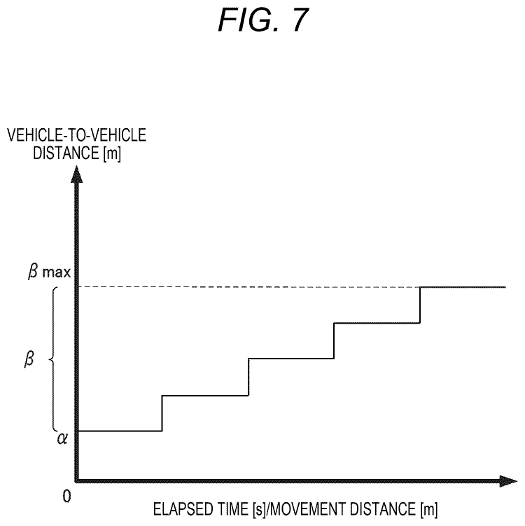

FIG. 6 is a graph for illustrating the vehicle-to-vehicle distance required for the lane change depending on the elapsed time (or movement distance) in the standby state. A horizontal axis shows the elapsed time (or the movement distance), and a vertical axis shows the vehicle-to-vehicle distance indicated by the threshold α and the threshold β. In the present embodiment, the threshold α in the first determination is a preset value, and the threshold β in the second determination is set to gradually increase as the elapsed time (or the movement distance) increases. Then, when a certain elapsed time (or movement distance) is reached, the threshold β becomes a maximum value (βmax). It should be noted that the threshold β may be increased to the maximum value βmax by a stepwise increase as shown in FIG. 7, in addition to a proportional increase.

Then, when the lane change execution unit 170 determines, using the function thereof, that the lane change is possible in the second determination, the control device 100 executes the lane change of the own vehicle M. Specifically, the control device 100 controls the blinker 83, the travel driving force output device 200, the brake device 210, and the steering device 220 using the function of the lane change execution unit 170, and performs the lane change of the own vehicle M to the adjacent lane. In this way, by temporarily setting the lane change to be on standby and then executing the lane change based on a result of the second determination that the lane change is determined to be possible, control according to an intention of lane change by the occupant is possible. In other words, in the case where the lane change is suspended without transitioning to a standby state when the lane change is determined to be impossible in the first determination, control according to an intention of lane change by the occupant cannot be performed. However, by temporarily transitioning to a standby state and then performing the lane change depending on the result of the second determination, it is possible to respond to the intention of lane change by the occupant. It should be noted that when executing the lane change based on the result of the second determination that the lane change is determined to be possible, the control device 100 starts turning on the blinker 83 after the lane change is determined to be possible in the second determination. If the blinker 83 is turned on before the lane change is determined to be possible in the second determination, the blinker may be turned on too early, which may cause discomfort or the like to the occupant of the own vehicle and occupants of other vehicles and the like.

It should be noted that if the control device 100 determines that the vehicle-to-vehicle distance L between the front vehicle M1 and the rear vehicle M2 is equal to or greater than the threshold α using the function of the lane change execution unit 170, the control device 100 performs the lane change of the own vehicle M to the adjacent lane without transitioning to the standby state described above.

### Second Lane Change Control

Next, the second lane change control will be described. It should be noted that the second lane change control differs from the first lane change control in that the lane change request is triggered by a half-lock operation on the blinker lever 81, and in that the second lane change control does not transition to a standby state in which the lane change is on standby. A logic for determining whether the lane change is possible is similar to that of the first lane change control. Therefore, the description of the same contents as those of the first lane change control will be omitted or simplified.

In the second lane change control, the control device 100 recognizes (or acquires) the surrounding situation of the own vehicle M in response to a half-lock operation on the blinker lever 81 through the function of the recognition unit 130. That is, the recognition unit 130 recognizes the surrounding situation of the own vehicle (here, the traveling states of other vehicles such as the front vehicle M1 and the rear vehicle M2) based on information input from the camera 10, the radar device 12, the LIDAR 14, and the like via the object recognition device 16, and based on the second map information 72. The recognition unit 130 then acquires the vehicle-to-vehicle distance L between the front vehicle M1 and the rear vehicle M2 from the traveling states such as positions, speeds, and accelerations of the other vehicles.

Next, the control device 100 uses the function of the lane change execution unit 170 to determine whether the lane change is possible. The determination as to whether the lane change is possible here may be similar to the first determination in the above-mentioned first lane change control. That is, when the vehicle-to-vehicle distance L between the front vehicle M1 and the rear vehicle M2 is determined to be equal to or greater than the threshold α using the function of the lane change execution unit 170, the control device 100 determines that the lane change is possible and performs the lane change of the own vehicle M to the adjacent lane.

On the other hand, when the vehicle-to-vehicle distance L between the front vehicle M1 and the rear vehicle M2 is determined to be less than the threshold α using the function of the lane change execution unit 170, the control device 100 determines that the lane change is impossible and does not perform the lane change of the own vehicle M to the adjacent lane.

### Example of Processing Executed by Control Device 100

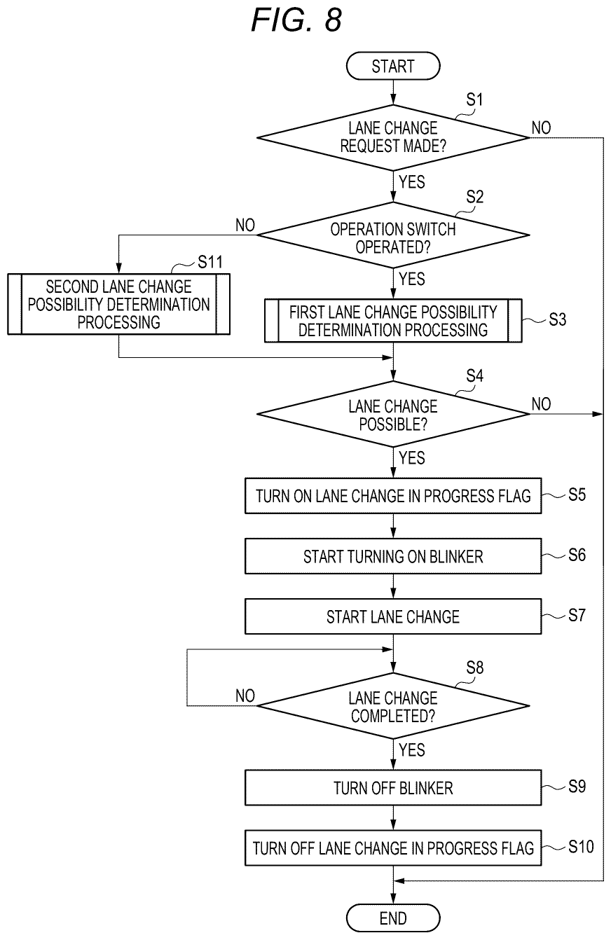

Next, an example of processing (lane change assistance processing) executed by the control device 100 will be described with reference to a flowchart. FIG. 8 is a flowchart showing an example of the processing, and the processing is repeatedly executed at a predetermined period when an ignition power of the own vehicle M is turned on, for example.

As shown in FIG. 8, first, the control device 100 determines whether there is a lane change request using the function of the lane change execution unit 170 (step S1). As described above, the lane change request is triggered by the occupant performing a half-lock operation on the blinker lever 81 or an operation on the operation switch SW1. Therefore, when it is determined that there is no lane change request (No in step S1), the control device 100 ends the execution of the lane change assistance processing shown in FIG. 8. On the other hand, when it is determined that there is a lane change request (Yes in step S1), the control device 100 advances the processing to step S2.

In step S2, the control device 100 determines whether the operation switch SW1 is operated as a trigger for the lane change request. A detection result of an operation on the operation switch SW1 or a half-lock operation is input to the control device 100. Therefore, the control device 100 determines by which method the lane change request is made. In this step S2, if it is determined that the operation switch SW1 is not operated (in other words, a half-lock operation is performed) (No in step S2), the control device 100 advances the processing to step S11 described below and executes second lane change possibility determination processing. On the other hand, if it is determined in step S2 that the operation switch SW1 is operated (Yes in step S2), the control device 100 executes first lane change possibility determination processing (step S3).

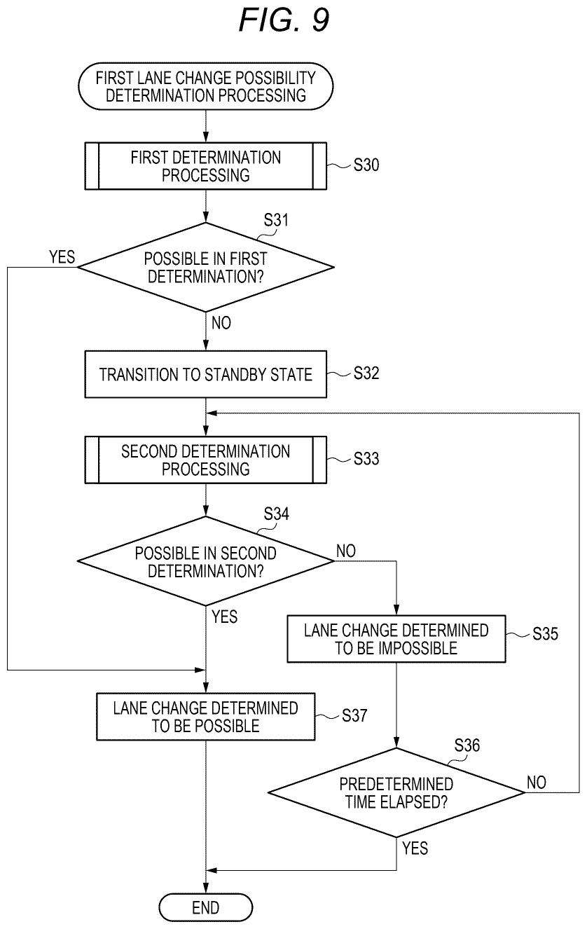

FIG. 9 is a flowchart (subroutine) showing an example of the first lane change possibility determination processing. In the first lane change possibility determination processing, the control device 100 executes the above-mentioned processing of the first determination (hereinafter referred to as “first determination processing”), or the first determination processing and processing of the second determination (hereinafter referred to as “second determination processing”), and determines whether the lane change of the own vehicle M is possible.

In the first lane change possibility determination processing, first, the control device 100 performs the first determination processing (step S30). As described above, the first determination processing is a determination as to whether the vehicle-to-vehicle distance L between the front vehicle M1 and the rear vehicle M2 traveling in the adjacent lane is equal to or greater than the threshold α.

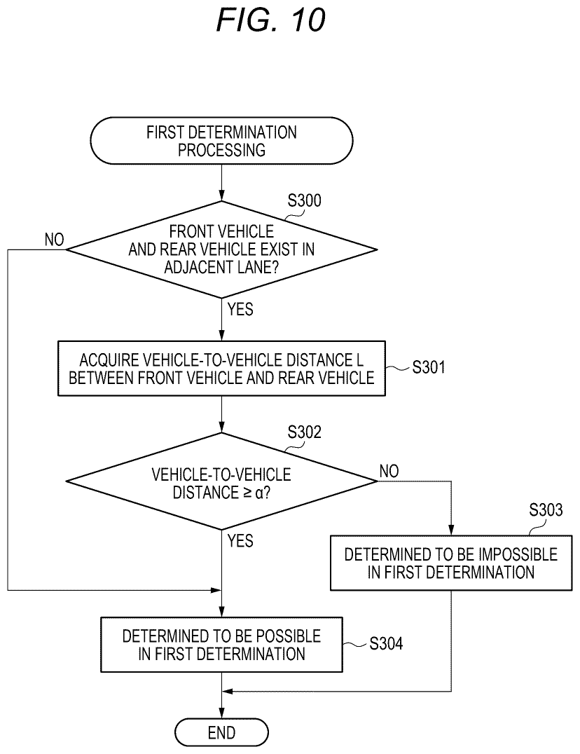

FIG. 10 is a flowchart (subroutine) showing an example of the first determination processing. In step S300, the control device 100 determines whether the front vehicle M1 and the rear vehicle M2 are present in the adjacent lane. That is, the control device 100 recognizes the surrounding situation of the own vehicle M, and determines whether the front vehicle M1 and the rear vehicle M2 are present in the adjacent lane using the function of the recognition unit 130. If it is determined that the front vehicle M1 and the rear vehicle M2 are present in the adjacent lane (Yes in step S300), the control device 100 advances the processing to step S301.

In step S301, the control device 100 acquires the vehicle-to-vehicle distance L between the front vehicle M1 and the rear vehicle M2. That is, the control device 100 uses the function of the recognition unit 130 to specify the positions, speeds, accelerations, and the like of the front vehicle M1 and the rear vehicle M2, and obtain the vehicle-to-vehicle distance L.

Next, the control device 100 uses the function of the lane change execution unit 170 to determine whether the vehicle-to-vehicle distance L acquired in step S301 is equal to or greater than the threshold α (step S302). As mentioned above, the threshold α is determined in advance based on the position and target speed of the own vehicle M, the positions and speeds of other vehicles, and the like. The control device 100 compares the vehicle-to-vehicle distance L acquired in step S301 with the threshold α, and determines that the lane change is impossible in the first determination (step S303) if the vehicle-to-vehicle distance L is determined to be less than the threshold α (No in step S302), and ends the execution of the first determination processing in FIG. 10.

On the other hand, if the vehicle-to-vehicle distance L is determined to be equal to or greater than the threshold α (Yes in step S302) and if it is determined in step S300 that the front vehicle M1 and the rear vehicle M2 are not present in the adjacent lane (No in step S300), the control device 100 determines that the lane change is possible in the first determination (step S304), and ends the execution of the first determination processing in FIG. 10.

With reference to FIG. 9 again, the control device 100 executes processing of step S31. In step S31, the control device 100 determines a result of the first determination processing described with reference to FIG. 10. If the result is negative in the determination (impossible in the first determination), the control device 100 transitions to a standby state in which the lane change of the own vehicle M is on standby (step S32). It should be noted that when the control device 100 transitions to the standby state, the control device 100 may use the function of the notification control unit 190 to notify in the HMI 30, the navigation HMI 62, or the like that the lane change is on standby.

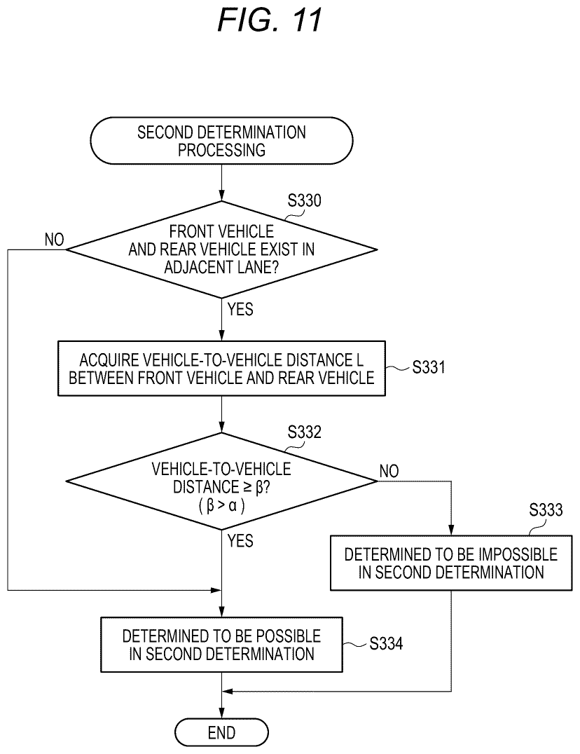

Next, the control device 100 performs the second determination processing (step S33). FIG. 11 is a flowchart (subroutine) showing an example of the second determination processing. In step S330, the control device 100 determines whether the front vehicle M1 and the rear vehicle M2 are present in the adjacent lane. That is, the control device 100 recognizes the surrounding situation of the own vehicle M, and determines whether the front vehicle M1 and the rear vehicle M2 are present in the adjacent lane using the function of the recognition unit 130. If it is determined that the front vehicle M1 and the rear vehicle M2 are present in the adjacent lane (Yes in step S330), the control device 100 advances the processing to step S331.

In step S331, the control device 100 acquires the vehicle-to-vehicle distance L between the front vehicle M1 and the rear vehicle M2. That is, the control device 100 uses the function of the recognition unit 130 to specify the positions, speeds, accelerations, and the like of the front vehicle M1 and the rear vehicle M2, and obtain the vehicle-to-vehicle distance L.

Next, the control device 100 uses the function of the lane change execution unit 170 to determine whether the vehicle-to-vehicle distance L acquired in step S331 is equal to or greater than the threshold β (step S332). Here, the threshold β has a value larger than that of the threshold α mentioned above. In other words, it can be assumed that the occupant is less vigilant about the surrounding situation since the own vehicle M is in the standby state, and therefore, the value of the threshold β is set to be larger than that of the threshold α. The control device 100 compares the vehicle-to-vehicle distance L acquired in step S331 with the threshold β, and determines that the lane change is impossible in the second determination (step S333) if the vehicle-to-vehicle distance L is determined to be less than the threshold β (No in step S332), and ends the execution of the second determination processing in FIG. 11.

On the other hand, if the vehicle-to-vehicle distance L is determined to be equal to or greater than the threshold β (Yes in step S332) and if it is determined in step S330 that the front vehicle M1 and the rear vehicle M2 are not present in the adjacent lane (No in step S330), the control device 100 determines that the lane change is possible in the second determination (step S334), and ends the execution of the second determination processing in FIG. 11.

With reference to FIG. 9 again, the control device 100 executes processing of step S34. In step S34, the control device 100 determines a result of the second determination processing described with reference to FIG. 11. If the result is negative in the determination (impossible in the second determination), the control device 100 determines that the lane change of the own vehicle M to the adjacent lane is impossible (step S35). If the lane change is determined to be impossible, the control device 100 advances the processing to step S36.

In step S36, the control device 100 determines whether a predetermined time elapses. The predetermined time here may be, for example, a time since becoming the standby state of step S32 (a time since executing the lane change assistance processing, or the like), and as described above, is, for example, 1.0 [min]. Then, if the predetermined time does not elapse (No in step S36), the processing returns to step S33 and the processing is repeatedly executed until the predetermined time elapses or until it is determined that the result of the second determination processing is positive (possible in the second determination) within the predetermined time. Then, if it is determined in step S36 that the predetermined time elapses (Yes in step S36), the control device 100 ends the execution of the first lane change possibility determination processing in FIG. 9. That is, the control device 100 ends the first lane change possibility determination processing while determining that the lane change is impossible.

On the other hand, if the result of the first determination processing is determined to be positive (possible in the first determination) in the above step S31, or if the result of the second determination processing is determined to be positive (possible in the second determination) in step S34, the control device 100 determines that the lane change of the own vehicle M to the adjacent lane is possible (step S37).

With reference to FIG. 8 again, the control device 100 determines whether the lane change is determined to be possible, based on the result of the first lane change possibility determination processing (step S4). If the lane change is determined to be impossible (No in step S4), the control device 100 ends the execution of the lane change assistance processing in FIG. 8. In other words, the lane change of the own vehicle M to the adjacent lane is suspended. It should be noted that, under this case, the control device 100 may use the function of the notification control unit 190 to notify in the HMI 30, the navigation HMI 62, or the like that the lane change is suspended.

On the other hand, if it is determined that the lane change is possible based on the result of the first lane change possibility determination processing (Yes in step S4), the control device 100 turns on a lane change in progress flag (step S5) and starts turning on the blinker 83 (step S6). It should be noted that the processing of turning on the lane change in progress flag in step S5 is a trigger for starting turning on the blinker 83.

Next, the control device 100 starts the lane change (step S7). That is, the control device 100, using the function of the lane change execution unit 170, starts lateral movement of the own vehicle M for performing the lane change to the adjacent lane. The lateral movement here refers to movement of the own vehicle M from a current travel lane to the adjacent lane, and in actual behavior, if a lane change from a left lane to a right lane is to be performed, the own vehicle M is moved forward and diagonally to the right.

During execution of the lane change, the control device 100 controls the travel driving force output device 200, the brake device 210, and the steering device 220 using the function of the lane change execution unit 170 to follow the target trajectory, and performs the lane change of the own vehicle M to the adjacent lane.

Next, the control device 100 determines whether the lane change of the own vehicle M to the adjacent lane is completed (step S8). Specifically, the control device 100 uses the function of the recognition unit 130 to specify the position and posture of the own vehicle M, and determines that the lane change is completed when, for example, the posture of the own vehicle M in the adjacent lane is parallel to a traveling direction. In step S8, if it is determined that the lane change of the own vehicle M is not completed yet (No in step S8), the control device 100 waits until the lane change is completed.

On the other hand, if it is determined in step S8 that the lane change of the own vehicle M is completed, the control device 100 turns off the blinker 83 (step S9). That is, when the lane change of the own vehicle M is completed, the control device 100 turns off the blinker 83 that is turned on in step S6. Then, after turning off the blinker 83, the control device 100 turns off the lane change in progress flag (step S10) and ends the execution of the lane change assistance processing in FIG. 8. After the lane change is completed (for example, at any timing of steps S8 to S10), the control device 100 may use the function of the notification control unit 190 to notify in the HMI 30, the navigation HMI 62, or the like that the lane change is completed. It should be noted that the above processing shown in FIGS. 8 to 11 is an example of the “first lane change control”.

Next, step S11 will be described. Step S11 is processing performed when the operation switch SW1 is not operated as a trigger for the lane change request in the above step S2 (in other words, when a half-lock operation is performed on the blinker lever 81), and the control device 100 executes the second lane change possibility determination processing.

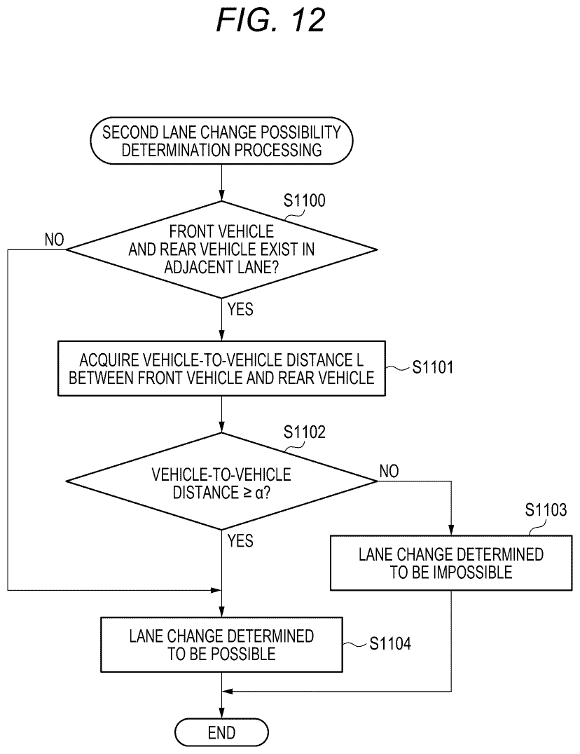

FIG. 12 is a flowchart (subroutine) showing an example of the second lane change possibility determination processing. The second lane change possibility determination processing is substantially similar to the first determination processing in the above-described first lane change possibility determination processing. Therefore, the description of the processing similar to the first determination processing will be omitted or simplified.

In step S1100, the control device 100 determines whether the front vehicle M1 and the rear vehicle M2 are present in the adjacent lane. That is, the control device 100 recognizes the surrounding situation of the own vehicle M, and determines whether the front vehicle M1 and the rear vehicle M2 are present in the adjacent lane using the function of the recognition unit 130. If it is determined that the front vehicle M1 and the rear vehicle M2 are present in the adjacent lane (Yes in step S1100), the control device 100 advances the processing to step S1101.

In step S1101, the control device 100 acquires the vehicle-to-vehicle distance L between the front vehicle M1 and the rear vehicle M2. That is, the control device 100 uses the function of the recognition unit 130 to specify the positions, speeds, accelerations, and the like of the front vehicle M1 and the rear vehicle M2, and obtain the vehicle-to-vehicle distance L.

Next, the control device 100 uses the function of the lane change execution unit 170 to determine whether the vehicle-to-vehicle distance L acquired in step S1101 is equal to or greater than the threshold α (step S1102). It should be noted that since the threshold used in step S1101 is related to the lane change request based on an operation on the blinker lever 81 by the occupant, it can be said that the occupant is highly vigilant about the surrounding situation as compared with when, for example, performing the lane change from a standby state in the above-mentioned first lane change possibility determination processing. Therefore, a value of the threshold may be the same as the above threshold α, or may be smaller than the threshold α in consideration of safety. In the example shown in FIG. 12, for convenience, the threshold is denoted as the threshold α same as the threshold in the first determination processing.

The control device 100 compares the vehicle-to-vehicle distance L acquired in step S1101 with the threshold α, and determines that the lane change is impossible if the vehicle-to-vehicle distance L is determined to be less than the threshold α (No in step S1102), and ends the execution of the second lane change possibility determination processing in FIG. 12 and advances the processing to step S4 in FIG. 8. On the other hand, if the vehicle-to-vehicle distance L is determined to be equal to or greater than the threshold α (Yes in step S1102) and if it is determined in step S1100 that the front vehicle M1 and the rear vehicle M2 are not present in the adjacent lane (No in step S1100), the control device 100 determines that the lane change is possible (step S1104), and ends the execution of the second lane change possibility determination processing in FIG. 12 and advances the processing to step S4 in FIG. 8. The processing from step S4 onward in FIG. 8 is as described above, and therefore the description thereof will be omitted here. It should be noted that the above processing shown in FIGS. 8 and 12 is an example of the “second lane change control”.

As described above, in the present embodiment, if the lane change is determined to be impossible in the first determination processing, the control device 100 transitions to the standby state, and performs the second determination from the standby state, and if the lane change is determined to be possible, the control device 100 executes the lane change. That is, even when the lane change is determined to be impossible in the first determination, there is a possibility that the lane change will be performed based on the result of the subsequent second determination. In this way, it is possible to execute the lane change intended by the occupant of the own vehicle M while reducing the effort required from the occupant of the own vehicle M as compared with a system that, for example, determines that the lane change is impossible in the first determination and immediately suspends the lane change. In other words, after the lane change is determined to be impossible once in respond to an operation of lane change by the occupant, even if the operation of lane change is not performed again, the possibility of lane change can be re-determined, and therefore, it is possible to increase the possibility of executing the lane change intended by the occupant of the own vehicle while reducing the effort required from the occupant of the own vehicle M.

It should be noted that if the lane change is determined to be possible in the first determination, the own vehicle M will execute the lane change without transitioning to a standby state, thereby enabling a lane change that best reflects the lane change intention (timing) of the occupant.

In the present embodiment, the condition (second condition) for determining whether the lane change is possible from the standby state is stricter than the condition (first condition) for determining whether the lane change is possible without a standby state. The first condition is for the lane change performed immediately after being triggered by the lane change operation from the occupant, and therefore is easy to reflect monitoring on the surrounding situation by the occupant, such as a vehicle-to-vehicle distance between the own vehicle and other vehicles traveling in the adjacent lane. On the other hand, the lane change from the standby state is triggered by the lane change operation by the occupant, but it is assumed that the occupant is less vigilant about the surrounding situation after transitioning to the standby state. In other words, the second condition for determining whether the lane change is possible is stricter than the first condition taking safety into greater consideration, since the occupant is less vigilant about the surrounding situation, and reliance on the control device 100 to monitor the surrounding situation becomes high. In this way, by changing the condition for lane change depending on whether the lane change is from a standby state, when the lane change is performed based on the relatively lenient first condition, the threshold for the vehicle-to-vehicle distance becomes smaller, increasing the possibility of the lane change being possible, thereby increasing the possibility of responding to the lane change request from the occupant. On the other hand, when the lane change is performed based on the relatively strict second condition, the lane change can be performed with greater consideration given to safety.

In the present embodiment, the relative distance (vehicle-to-vehicle distance L) in the second determination gradually increases according to the elapsed time and the movement distance. That is, the second condition in the second determination for determining the lane change becomes gradually stricter. Therefore, as compared with a case where the vehicle-to-vehicle distance L in the second determination is made uniform for example, it becomes possible to perform the lane change with a feeling closer to the timing at which the occupant shows his or her intention to perform the lane change. In other words, in the case where the vehicle-to-vehicle distance L in the second determination is made uniform, the value of the threshold β described with reference to FIG. 6 is uniformly set to, for example, βmax, but as in the present embodiment, by gradually increasing the threshold β according to the elapsed time or the movement distance, a time is long during which at least the threshold β is a vehicle-to-vehicle distance shorter than βmax, and therefore opportunities for determining that the lane change is possible increase. As a result, there are more opportunities to respond to the lane change intention of the occupant.

In the present embodiment, the lane change request from the occupant is triggered by an operation on the operation switch SW1 or a half-lock operation on the blinker lever 81. In addition, the processing of transitioning to the above-mentioned standby state and determining whether the lane change is possible (first lane change control) is executed when a lane change request is made by the operation switch SW1, and will not be executed when a lane change request is made by the half-lock operation. The blinker 83 usually starts to be turned on when the blinker lever 81 is operated. Therefore, for example, in a case where the first lane change control is executed even when a lane change request is made by a half-lock operation on the blinker lever 81, the blinker 83 may continue to be turned on during the standby state, which may cause discomfort and the like to the occupant of the own vehicle M and occupants of other vehicles. On the other hand, when a lane change request is made by the operation switch SW1, the blinker 83 starts to be turned on after the lane change is determined to be possible in the second determination processing after transitioning to the standby state, and therefore, there is no inconvenience such as the blinker 83 turning on too early (in other words, it can be turned on at an appropriate timing), and as a result, the possibility of causing discomfort to the occupant of the own vehicle M or occupants of other vehicles is reduced.

When a lane change request is made by a half-lock operation and the first lane change control is executed, as described above, even if the blinker 83 does not remain on during the standby state, the blinker 83 will be turned on once at the timing of performing the half-lock operation. However, in the case of a lane change request made by the operation switch SW1, the blinker 83 will start to be turned on after the lane change is determined to be possible (in other words, there is no case where the lane change is impossible after the blinker 83 is turned on), and therefore, it is possible to accurately notify the surrounding vehicles and the like that a lane change is to be performed.

In the present embodiment, when a lane change request is made by a half-lock operation on the blinker lever 81, the second lane change control is executed. In other words, if it is determined that the lane change is impossible when the half-lock operation is performed, the lane change will not be performed without transitioning to the standby state. In this way, it is possible to prevent the blinker 83 from being turned on in the standby state, for example, when a half-lock operation is performed. The half-lock operation may be interpreted as an intention of the occupant to perform a lane change at that timing, and it can be said that the above-mentioned standby state does not occur. Therefore, it is possible to prevent the lane change from being performed while the occupant recognizes that the lane change control (second lane change control) is once ended.

Furthermore, execution of the lane change assistance as described above can contribute to development of a sustainable transportation system in consideration of vulnerable traffic participants.

### Other Embodiment

Next, the other embodiment will be described. In the above embodiment, the lane change assistance processing based on an operation on the operation switch SW1 or an operation (half-lock operation) on the blinker lever 81 by the occupant has been described. On the other hand, as described above, the control device 100 has the function of the lane change suggestion unit 180, and the lane change suggestion unit 180 may make a suggestion on the lane change to the occupant of the own vehicle M. With respect to the suggestion on the lane change, if the occupant of the own vehicle M agrees to the lane change by operating the approval selection switch SW2 or the like, a lane change based on a third lane change control is executed by the lane change execution unit 170.

### Third Lane Change Control

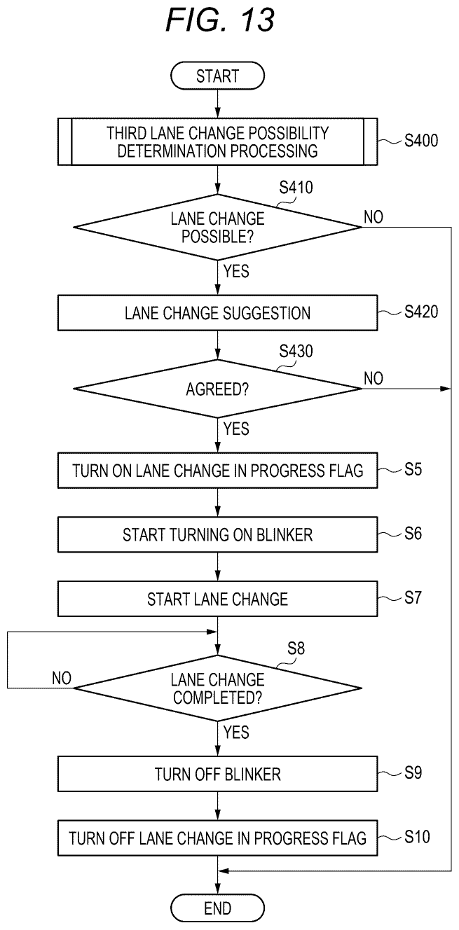

The third lane change control differs from the first lane change control described above in that the lane change is triggered by an agreement to the suggestion from the lane change suggestion unit 180 by an operation on the approval selection switch SW2, but has the same logic for determining whether the lane change is possible and for executing the lane change as that of the first lane change control. Therefore, detailed description of the contents will be omitted here, and an example of the processing will be described with reference to a flowchart shown in FIG. 13.

### Other Example of Processing Executed by Control Device 100

FIG. 13 is a flowchart showing the other example of the processing (lane change assistance processing) executed by the control device 100. This processing is executed repeatedly at a predetermined period, for example, when the ignition power of the own vehicle M is turned on. It should be noted that, as described above, this processing includes the same processing as the first lane change control (the processing in FIG. 8). Therefore, the same processing is given the same step numbers and descriptions thereof are omitted or simplified.

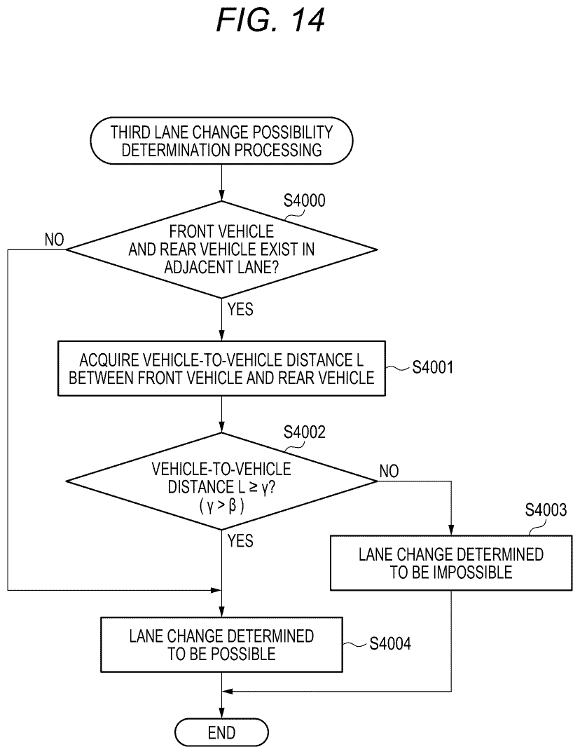

First, the control device 100 executes third lane change possibility determination processing (step S400). FIG. 14 is a flowchart (subroutine) showing an example of the third lane change possibility determination processing. The third lane change possibility determination processing is substantially similar to the first determination processing in the above-described first lane change possibility determination processing. Therefore, the description of the processing similar to the first determination processing will be omitted or simplified.

In step S4000, the control device 100 determines whether the front vehicle M1 and the rear vehicle M2 are present in the adjacent lane. That is, the control device 100 recognizes the surrounding situation of the own vehicle M, and determines whether the front vehicle M1 and the rear vehicle M2 are present in the adjacent lane using the function of the recognition unit 130. If it is determined that the front vehicle M1 and the rear vehicle M2 are present in the adjacent lane (Yes in step S4000), the control device 100 advances the processing to step S4001.

In step S4001, the control device 100 acquires the vehicle-to-vehicle distance L between the front vehicle M1 and the rear vehicle M2. That is, the control device 100 uses the function of the recognition unit 130 to specify the positions, speeds, accelerations, and the like of the front vehicle M1 and the rear vehicle M2, and obtain the vehicle-to-vehicle distance L.

Next, the control device 100 uses the function of the lane change execution unit 170 to determine whether the vehicle-to-vehicle distance L acquired in step S4001 is equal to or greater than a threshold γ (step S4002). It should be noted that the threshold γ in step S4002 in the example shown in FIGS. 13 and 14 is for a lane change triggered by a suggestion made by the lane change suggestion unit 180, and therefore, it can be said that the occupant is less vigilant about the surrounding situation as compared with, for example, an operation on the blinker lever 81 or an operation on the operation switch SW1. Therefore, it is preferable that a value of the threshold γ be set in consideration of greater safety than the above-mentioned threshold α and threshold β. Therefore, the threshold γ is greater than the threshold β.

The control device 100 compares the vehicle-to-vehicle distance L acquired in step S4001 with the threshold γ, and determines that the lane change is impossible (step S4003) if the vehicle-to-vehicle distance L is determined to be less than the threshold γ (No in step S4002), and ends the execution of the third lane change possibility determination processing in FIG. 14 and advances the processing to step S410 in FIG. 13. On the other hand, if the vehicle-to-vehicle distance L is determined to be equal to or greater than the threshold γ (Yes in step S4002) or if it is determined in step S4000 that the front vehicle M1 and the rear vehicle M2 are not present in the adjacent lane (No in step S4000), the control device 100 determines that the lane change is possible (step S4004), and ends the execution of the third lane change possibility determination processing in FIG. 14 and advances the processing to step S410 in FIG. 13.

With reference to FIG. 13 again, in step S410, the control device 100 determines whether the lane change is determined to be possible, based on the result of the third lane change possibility determination processing (step S410). If the lane change is determined to be impossible (No in step S410), the control device 100 ends the execution of the lane change assistance processing in FIG. 13.

On the other hand, if it is determined that the lane change is possible based on the result of the third lane change possibility determination processing (Yes in step S410), the control device 100 uses the function of the lane change suggestion unit 180 to make a suggestion on the lane change (step S420). Specifically, the lane change suggestion unit 180 makes a suggestion on the lane change to the occupant of the own vehicle M based on the surrounding situation recognized by the recognition unit 130 and the target trajectory generated by the action plan generating unit 140. The suggestion is made, for example, by using the function of the notification control unit 190 to notify in the HMI 30, the navigation HMI 62, or the like as to whether to make a suggestion on a lane change.

Next, the control device 100 determines whether the suggestion on the lane change made in step S420 is approved (step S430). If the occupant agrees to the suggestion on the lane change made in step S420, the occupant operates the approval selection switch SW2 to give agreement. Even when the occupant does not agree to the suggestion on the lane change, the approval selection switch SW2 is also operated. The control device 100 detects the operation on the approval selection switch SW2 and determines whether the lane change is approved. If it is determined that the lane change is not approved (No in step S430), the control device 100 ends the execution of the lane change assistance processing in FIG. 13.

On the other hand, if it is determined that the lane change is approved (Yes in step S430), the control device 100 advances the processing to step S5, turns on the lane change in progress flag (step S5), and starts turning on the blinker 83 (step S6). The processing from step S6 onward in FIG. 13 is the same as in FIG. 8 as described above, and therefore the description thereof will be omitted here. It should be noted that the processing shown in FIGS. 13 and 14 is an example of the “third lane change control”.

In this way, when the lane change suggestion unit 180 makes a suggestion on the lane change, the lane change is triggered by an agreement from the occupant, making it possible to perform the lane change according to the intention of the occupant.

It should be noted that in step S430 described above, a timing at which the approval selection switch SW2 is operated in response to the suggestion on the lane change may differ depending on the occupant. For example, if there is a time lag of a predetermined time or more from the suggestion on the lane change in step S420, even if the lane change is determined to be possible in the third lane change possibility determination processing, the lane change may be determined to be impossible during that time lag. Therefore, when it is determined in step S430 that the lane change is approved, the control device 100 may perform the processing of determining again whether the lane change is possible. Then, when it is determined that the lane change is possible by determining again whether the lane change is possible, the control device 100 may advance the processing to step S5.

### Others

Although each of the embodiments has been described above with reference to the drawings, it is needless to say that the present invention is not limited to the embodiments. It is apparent that those skilled in the art can conceive of various modifications and changes within the scope described in the claims, and it is understood that such modifications and changes naturally fall within the technical scope of the present invention. In addition, the constituent elements in the above embodiments may be freely combined without departing from the gist of the invention.

In the above-described embodiments, the vehicle-to-vehicle distance L between the front vehicle M1 and the rear vehicle M2 traveling in the adjacent lane is described as an example of a parameter indicating a condition related to a relative distance. However, as described above, the parameter may also be, for example, a relative speed between the own vehicle M and the other vehicle (the front vehicle M1 or the rear vehicle M2) or a relative distance between the own vehicle M and the other vehicle (the front vehicle M1 or the rear vehicle M2). In such a case, the control device 100, using the function of the recognition unit 130, obtains the relative speed (or relative distance) between the own vehicle M and the other vehicle based on a current speed and a target speed of the own vehicle, as well as the speed, acceleration, and the like of the other vehicle, and determines whether the lane change is possible based on the obtained relative speed (or relative distance) to perform the lane change. It should be noted that it is sufficient to adopt at least one parameter as the parameter indicating the condition related to the relative distance, but a plurality of parameters may be adopted. By adopting a plurality of parameters, even when the vehicle-to-vehicle distance between the front vehicle M1 and the rear vehicle M2 is relatively large, if the rear vehicle M2 is traveling at a large speed difference with respect to the own vehicle M, such as 30 [km/h], the lane change may be determined to be impossible. On the other hand, for example, even when the vehicle-to-vehicle distance between the front vehicle M1 and the rear vehicle M2 is relatively small, if the speed difference between the rear vehicle M2 and the own vehicle M is minus 30 [km/h] and the own vehicle M is traveling at a higher speed, the lane change may be determined to be possible.

In this way, by determining whether the lane change is possible based on a plurality of parameters and then executing the lane change, it is possible to perform a lane change while taking safety into greater consideration. On the other hand, by adopting fewer parameters, the determination of whether the lane change is possible is more lenient than when a plurality of parameters are adopted, while still ensuring safety, thereby increasing the possibility of executing the lane change. As a result, it is more likely to be able to respond to the intention of lane change of the occupant. It should be noted that the selection of parameters to be adopted and the number of parameters may be customized as appropriate by the manufacturer of the own vehicle M and the like. For example, the parameters to be adopted may be changed depending on the type of vehicle in which the system is adopted.

Although the above-described control device 100 includes two control units, the first control unit 120 and the second control unit 160, the control unit may be one unit or may be divided into more control units. For example, at least some of the functional units (recognition unit 130, action plan generating unit 140, lane change execution unit 170, lane change suggestion unit 180, notification control unit 190) constituting the first control unit 120 and the second control unit 160 may exist separated into a plurality of devices, such as being implemented by a server.

In the above embodiments, the operation switch SW1 and the approval selection switch SW2 are described as different switches, but the operation switch SW1 and the approval selection switch SW2 may be the same switch. One of the switches may have both the function of the operation switch SW1 and the function of the approval selection switch SW2. In that case, one switch allows the lane change and the agreement to the suggestion on the lane change. In the above embodiments, although the threshold γ in step S4002 is described as being greater than the threshold β, the threshold γ may be the same as the threshold β.

The control method described in the above embodiments can be implemented by executing a prepared control program on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. In the parentheses, the corresponding constituent elements and the like in the above embodiment are shown as an example, but the present invention is not limited thereto.

(1) A lane change assistance device (control device 100) capable of assisting lane change of an own vehicle (own vehicle M) from an own lane (left lane 112) in which the own vehicle travels to an adjacent lane (right lane 111) adjacent to the own lane, the lane change assistance device including:
a recognition unit (recognition unit 130) configured to recognize a surrounding situation of the own vehicle; and
a lane change execution unit (lane change execution unit 170) configured to perform the lane change based on the surrounding situation recognized by the recognition unit, in which
the lane change execution unit executes a first lane change control in response to an operation on a predetermined operator provided in the own vehicle, the first lane change control including
   performing a first determination to determine whether the lane change is possible based on the surrounding situation,
   if the lane change is determined to be impossible in the first determination, transitioning to a standby state in which execution of the lane change is on standby,
   after transitioning to the standby state, performing a second determination to determine whether the lane change is possible based on the surrounding situation, and
   if the lane change is determined to be possible in the second determination, performing the lane change.

According to (1), it is possible to execute the lane change intended by the occupant of the own vehicle while reducing the effort required from the occupant of the own vehicle as compared with a system that, for example, determines that the lane change is impossible in the first determination and immediately suspends the lane change. In other words, after the lane change is determined to be impossible once in respond to an operation of lane change by the occupant, even if the operation of lane change is not performed again, the possibility of lane change can be re-determined, and therefore, it is possible to increase the possibility of executing the lane change intended by the occupant of the own vehicle while reducing the effort required from the occupant of the own vehicle.

(2) The lane change assistance device according to (1), in which
if the lane change is determined to be possible in the first determination, the lane change execution unit performs the lane change without transitioning to the standby state.

According to (2), if the lane change is determined to be possible in the first determination, the own vehicle will execute the lane change without transitioning to a standby state, thereby enabling a lane change that best reflects the lane change intention (timing) of the occupant.

(3) The lane change assistance device according to (1), in which
the lane change execution unit determines, in the first determination, that the lane change is possible if the surrounding situation satisfies a first condition, and
the lane change execution unit determines, in the second determination, that the lane change is possible if the surrounding situation satisfies a second condition stricter than the first condition.

According to (3), by making the second condition for determining whether the lane changing is possible while in the standby state stricter than the first condition, for example, even if the occupant of the own vehicle is less vigilant about the surrounding situation while in the standby state, the stricter condition for determining whether the lane change is possible makes it possible to change lanes while taking safety into consideration.

(4) The lane change assistance device according to (3), in which
the first condition and the second condition each include a condition related to a relative distance (vehicle-to-vehicle distance L) between the own vehicle and the other vehicle (front vehicle M1, rear vehicle M2) traveling in the adjacent lane, and
the relative distance in the second determination is longer than the relative distance in the first determination.

According to (4), by making the vehicle-to-vehicle distance in the second condition longer than the vehicle-to-vehicle distance in the first condition, for example, even if the occupant of the own vehicle is less vigilant about the surrounding situation while in the standby state, the stricter condition (vehicle-to-vehicle distance) for determining whether the lane change is possible makes it possible to change lanes while taking safety into consideration.

(5) The lane change assistance device according to (4), in which
the relative distance in the second condition gradually increases according to an elapsed time or a movement distance.

According to (5), as compared with a case where the vehicle-to-vehicle distance in the second condition is set to, for example, a fixed value, by gradually increasing the vehicle-to-vehicle distance in the second condition, the vehicle-to-vehicle distance will be shorter than the fixed vehicle-to-vehicle distance until the fixed vehicle-to-vehicle distance is reached, thereby increasing the opportunities for determining that the lane change is possible and making it possible to perform the lane change with a feeling closer to the timing at which the occupant shows his or her intention to perform the lane change.

(6) The lane change assistance device according to (1), in which
the operator is an operator (operation switch SW1) different from a blinker lever (blinker lever 81).

According to (6), when a lane change request is made by the operation switch, the first lane change control is executed, and when a lane change request is made by the blinker lever, the first lane change control is not executed. Therefore, if a lane change request is made by the blinker lever and the first lane change control is executed, the blinker would be turned on during the standby state, but such an event will not occur. As a result, it is possible to prevent the occupant of the own vehicle and occupants of other vehicles from feeling discomfort due to the blinker being turned on during the standby state.

(6) The lane change assistance device according to (7), in which
the lane change execution unit executes a second lane change control in response to a predetermined operation on the blinker lever, the second lane change control including
   performing the lane change if the lane change is determined to be possible based on the surrounding situation, and
   not performing the lane change if the lane change is determined to be impossible based on the surrounding situation.

According to (7), for example, when a half-lock operation is performed, the device does not transition to a standby state, so that it is possible to prevent the blinker from being turned on in the standby state.

(8) The lane change assistance device according to (6), in which
the lane change execution unit is configured to
   not turn on a turn signal light (blinker 83) if merely the operator is operated, and
   turn on the turn signal light if the lane change is determined to be possible in the first determination, or when the lane change is determined to be impossible in the first determination and the lane change is determined to be possible in the second determination.

According to (8), when a lane change request is made by the operation switch, the blinker starts to be turned on after the lane change is determined to be possible in the second determination processing after transitioning to the standby state, and therefore, there is no inconvenience such as the blinker being turned on too early, and in other words, the blinker can be turned on at an appropriate timing.

(9) The lane change assistance device according to (1), further including:
a lane change suggestion unit (lane change suggestion unit 180) configured to make a suggestion on the lane change to an occupant of the own vehicle, in which
the lane change execution unit executes a third lane change control to perform the lane change in response to an operation to agree to the suggestion made by the lane change suggestion unit, and
the lane change execution unit executes the first lane change control in response to an operation on the operator when the suggestion is not made.

According to (9), when the lane change suggestion unit makes a suggestion on the lane change, the lane change is triggered by an agreement from the occupant, making it possible to perform the lane change according to the intention of the occupant.

### REFERENCE SIGNS LIST

81 blinker lever
83 blinker
100 control device (lane change assistance device)
111 right lane (adjacent lane)
112 left lane (own lane)
130 recognition unit
170 lane change execution unit
180 lane change suggestion unit
L vehicle-to-vehicle distance (relative distance)
M own vehicle
M1 front vehicle (other vehicle)
M2 rear vehicle (other vehicle)
SW1 operation switch

What is claimed is:

1. A lane change assistance device capable of assisting lane change of an own vehicle from an own lane in which the own vehicle travels to an adjacent lane adjacent to the own lane, the lane change assistance device comprising:
a recognition unit configured to recognize a surrounding situation of the own vehicle; and
a lane change execution unit configured to perform the lane change based on the surrounding situation recognized by the recognition unit, wherein
the lane change execution unit executes a first lane change control in response to an operation on a predetermined operator provided in the own vehicle, the first lane change control comprising
performing a first determination to determine whether the lane change is possible or impossible based on the surrounding situation,
in a case where the lane change is determined to be impossible in the first determination, transitioning to a standby state in which execution of the lane change is on standby,
after transitioning to the standby state, performing a second determination to determine whether the lane change is possible or impossible based on the surrounding situation, and
in a case where the lane change is determined to be possible in the second determination, performing the lane change.

2. The lane change assistance device according to claim 1, wherein
in a case where the lane change is determined to be possible in the first determination, the lane change execution unit performs the lane change without transitioning to the standby state.

3. The lane change assistance device according to claim 1, wherein
the lane change execution unit determines, in the first determination, that the lane change is possible in a case where the surrounding situation satisfies a first condition, and
the lane change execution unit determines, in the second determination, that the lane change is possible in a case where the surrounding situation satisfies a second condition stricter than the first condition.

4. The lane change assistance device according to claim 3, wherein
the first condition and the second condition each include a condition related to a relative distance between the own vehicle and other vehicle traveling in the adjacent lane, and
the relative distance in the second determination is longer than the relative distance in the first determination.

5. The lane change assistance device according to claim 4, wherein
the relative distance in the second condition gradually increases according to an elapsed time or a movement distance.

6. The lane change assistance device according to claim 1, wherein
the operator is an operator different from a blinker lever provided in the own vehicle.

7. The lane change assistance device according to claim 6, wherein
the lane change execution unit executes a second lane change control in response to a predetermined operation on the blinker lever, the second lane change control comprising
performing the lane change in a case where the lane change is determined to be possible based on the surrounding situation, and
not performing the lane change in a case where the lane change is determined to be impossible based on the surrounding situation.

8. The lane change assistance device according to claim 6, wherein
the lane change execution unit is configured to
not turn on a turn signal light in a case where the operator is merely operated, and
turn on the turn signal light in a case where the lane change is determined to be possible in the first determination, or in a case where the lane change is determined to be impossible in the first determination and the lane change is determined to be possible in the second determination.

9. The lane change assistance device according to claim 1, further comprising:
a lane change suggestion unit configured to make a suggestion on the lane change to an occupant of the own vehicle, wherein
the lane change execution unit executes a third lane change control to perform the lane change in response to an operation to agree to the suggestion made by the lane change suggestion unit, and
the lane change execution unit executes the first lane change control in response to an operation on the operator when the suggestion is not made.
